(19) United States
(12) Patent Application Publication
(10) Pub. No.: US 2026/0170938 A1
(43) Pub. Date: Jun. 18, 2026

(54) EMERGENCY NOTIFICATION APPLICATION WITH SECONDARY USER MONITORING AND ALERTING

(71) Applicant: MOTOROLA SOLUTIONS, INC., CHICAGO, IL (US)

(72) Inventors: CHEE YEW CHEONG, SUBANG JAYA (MY); SEOH LI CHUA, TAIPING (MY); ANOOP SEHGAL PARAS RAM, IPOH (MY); YEW TATT SIM, BUTTERWORTH (MY); CHEN HANG CHIA, ALOR SETAR (MY)

(21) Appl. No.: 18/983,427

(22) Filed: Dec. 17, 2024

(51) Int. Cl. G08B 25/00; G06V 10/70; G06V 20/52; G08B 25/01; G08B 25/10

(52) U.S. Cl. CPC G08B 25/001; G06V 10/87; G06V 20/52; G08B 25/016; G08B 25/10

(57) ABSTRACT

An emergency notification system providing panic button functionalities to a primary user can have its functionalities extended to detect and respond to emergencies involving a secondary user remotely located from the primary user. The system receives video footage of the secondary user in accordance with specified times and locations and applies video analytics algorithms to detect an emergency incident. The system sends an alert to the primary user along with the relevant video footage. Upon confirmation by the primary user, the system sends an alert to the appropriate emergency response agency that includes the video footage, a location of the secondary user, and an indication of the type of emergency.

### BACKGROUND OF THE INVENTION

Emergency notification applications, such as panic button applications, are software programs designed to provide users with a quick and easy way to call for help in emergency situations. Such applications are often designed for use with a mobile device and typically feature one or more prominent buttons that, when pressed, trigger a predefined emergency response. This response could involve sending an alert with location information to an emergency response service, such as a public safety answering point (PSAP).

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 illustrates a public safety communications system, according to some examples.

FIG. 2A illustrates a schematic diagram of an emergency notification system for performing various operations described herein, according to some examples.

FIG. 2B illustrates a schematic diagram of a computing system for performing various operations described herein, according to some examples.

FIG. 3 illustrates a user interface of a mobile device running an emergency notification application, according to some examples.

FIG. 4 illustrates another user interface of the mobile device running the emergency notification application, according to some examples.

FIG. 5 illustrates still another user interface of the mobile device running the emergency notification application, according to some examples.

FIG. 6 illustrates a method for extending functions of the emergency notification application to a secondary user remotely located from a primary user of the application, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION OF THE INVENTION

An emergency notification application, such as a panic button application, can be effective at providing emergency assistance for an individual using the application, as it provides a quick and easy way for the individual to request such emergency assistance. Similarly, when the individual witnesses someone in their immediate vicinity who is in need of emergency assistance, the individual can also use the emergency notification application to initiate an emergency response for that other individual

However, conventional emergency notification applications lack functionality that allows a user to quickly and easily request emergency assistance for someone who is remotely located from the user. Such functionality could be useful for users who are responsible for the care of others but are not always in their immediate vicinity. As one example, parents or guardians may wish to be able to detect when their child or other dependent is involved in an emergency incident while away (e.g., at daycare, school, camp, sporting event, etc.) and quickly request emergency assistance for their child or dependent. As another example, a user may wish to similarly request emergency assistance for someone with mobility issues who may be less capable of seeking assistance on their own, such as an elderly or infirm family member or friend who lives apart from the user. Other applicable examples are contemplated herein as well.

Thus, there is a need for improved mechanisms for extending the functionality of emergency notification applications to detect and report emergency incidents involving dependents or other individuals remotely located from a user. One example provides a method involving: (i) receiving video footage captured in an environment of a first individual; (ii) applying a video analytics algorithm to the video footage to detect a potential emergency incident involving the first individual; (iii) in response to detecting the potential emergency incident involving the first individual, (a) identifying a communication device of a second individual based on an identifier of the communication device of the second individual being stored in association with an identifier of the first individual, and (b) causing the communication device of the second individual to output an alert, wherein the alert comprises (I) at least a portion of the video footage of the first individual and (II) a prompt for approving or rejecting activation of an emergency function; (iv) determining whether the communication device of the second individual has received a user input comprising an approval or rejection of the activation of the emergency function; (v) when the user input comprises an approval of the activation of the emergency function, proceeding to activate the emergency function by establishing a connection with a computing device at a public safety access point (PSAP) and sending to the computing device at the PSAP (a) at least the portion of the video footage of the first individual and (b) a location of the environment of the first individual; and (vi) when the user input comprises a rejection of the activation of the emergency function, refraining from activating the emergency function.

In some aspects of the method, the first individual is a dependent of the second individual, and the identifier of the communication device of the second individual is stored in association with the identifier of the first individual based on the first individual being a dependent of the second individual.

In some aspects of the method, the prompt for approving or rejecting the activation of an emergency function is associated with a timer, wherein determining whether the communication device of the second individual has received a user input comprising an approval or rejection of the activation of the emergency function comprises determining that the timer has expired prior to receiving the user input, and wherein the method further comprises proceeding to activate the emergency function based on determining that the timer has expired prior to receiving the user input.

In some aspects of the method, the alert further comprises a prompt for an additional user input comprising (i) a type of the emergency incident involving the first individual or (ii) a type of desired emergency response to the emergency incident involving the first individual, wherein the method further comprises receiving data representing the additional user input, and wherein activating the emergency function further comprises sending an indication of the additional user input to the computing device at the PSAP.

In some aspects of the method, the method further comprises automatically tuning the video analytics algorithm based on the user input comprising an approval or rejection of the activation of the emergency function.

In some aspects of the method, the video analytics algorithm comprises at least one of: (i) a first video analytics algorithm for determining whether the first individual has fallen; (ii) a second video analytics algorithm for determining whether the first individual is engaged in physical violence; (iii) a third video analytics algorithm for determining whether the first individual has departed the environment; (iv) a fourth video analytics algorithm for detecting fire or smoke in the environment; or (v) a fifth video analytics algorithm for detecting a weapon in the environment.

In some aspects of the method, the method further comprises, prior to applying the video analytics algorithm to the video footage, (i) receiving, from the communication device of the second individual, data identifying one or more types of emergency incidents, and (ii) selecting a particular video analytics algorithm based on the particular video analytics algorithm corresponding to the identified one or more types of emergency incidents, and wherein applying the video analytics algorithm to the video footage comprises applying the selected particular video analytics algorithm to the video footage.

In some aspects of the method, the method further comprises, prior to applying the video analytics algorithm to the video footage, receiving, from the communication device of the second individual, data identifying a time period or a location, and wherein applying the video analytics algorithm to the video footage comprises applying the video analytics algorithm to the video footage only during the identified time period or only when the environment of the first individual is at the identified location.

In some aspects of the method, the communication device of the second individual is executing an emergency application configured to establish a connection with the PSAP when a panic button of the emergency application is activated, wherein causing the communication device of the second individual to output the alert comprises causing the communication device of the second individual to output the alert via the emergency application, and wherein the communication device of the second individual receives the user input comprising the approval or rejection of the activation of the emergency function via the emergency application.

In some aspects of the method, the method further comprises: (i) receiving, from the communication device of the second individual, a communication indicative of an emergency incident, wherein the communication is received in response to the actuation of a panic button on the communication device of the second individual, and wherein the communication comprises a location of the communication device of the second individual; and (ii) in response to receiving the communication indicative of the emergency incident, establishing a connection with the computing device at the PSAP and sending to the computing device at the PSAP the location of the communication device of the second individual.

Another example provides a computing system comprising: (i) at least one processor; and (ii) non-transitory computer-readable data storage comprising program instructions that, when executed by the at least one processor, cause the computing system to perform any or all aspects of the example method described above.

Still another example provides an alert system comprising: (i) a camera arranged to capture the video footage of the environment of the first individual; (ii) at least one processor; and (iii) non-transitory, computer-readable data storage comprising program instructions that, when executed by the at least one processor, cause the alert system to perform any or all aspects of the example method described above.

Each of the above-mentioned examples will be discussed in more detail below, starting with example system and device architectures of the system in which the examples may be practiced, followed by an illustration of processing blocks for achieving an improved technical method, device, and system for extending the functionality of emergency notification applications to detect and report emergency incidents involving dependents or other individuals remotely located from a user.

Examples are herein described with reference to flowchart illustrations and/or block diagrams of methods, apparatus (systems and devices), and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the operations specified in the flowchart and/or block diagram block or blocks. The methods and processes set forth herein need not, in some examples, be performed in the exact sequence as shown and, where possible, various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

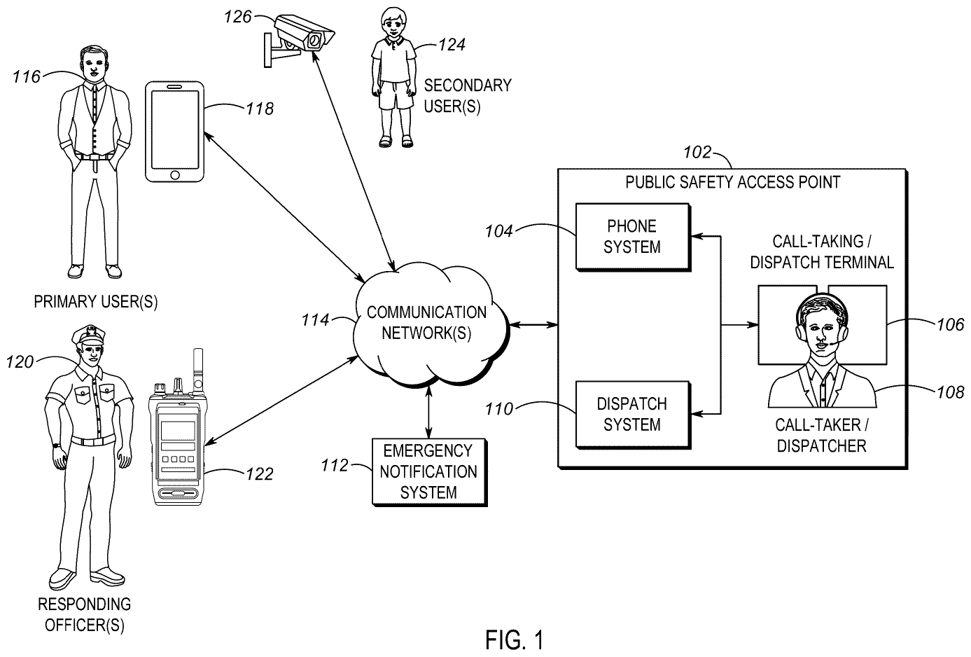

Referring now to the drawings, FIG. 1 illustrates an example public safety communications system 100. It should be understood that the system 100 is provided as one example and, in some instances, the system 100 may include fewer or additional components than those illustrated. As would be understood by one skilled in the art, FIG. 1 is a simplified diagram and, in practice, public safety communication systems can be more complex than the schematic elements depicted in FIG. 1.

In the illustrated example, the system 100 includes PSAP 102 (for example, an emergency call center) having a phone system 104, a call-taking/dispatching terminal 106, a call-taker/dispatcher 108 associated with the call-taking/dispatching terminal 106, and a dispatch system 110. While illustrated for simplicity as including a single call-taking/dispatching terminal 106 and call-taker/dispatcher 108, it should be understood that the PSAP 102 may include multiple call-taking/dispatching terminals 106 and multiple call-takers/dispatchers 108. Further, in some examples of the PSAP 102, the call-taking and dispatching functions may be performed by disparate systems, such that the PSAP 102 includes separate call-taking and dispatching terminals as well as separate call-takers and dispatchers that interface with such terminals. Additionally, while the phone system 104 and the dispatch system 110 are illustrated for simplicity as individual systems residing at the PSAP 102, these systems may alternatively be implemented in a distributed manner at the PSAP 102 and/or remotely from the PSAP 102. In some instances, any or all of these systems are implemented in whole or in part by a cloud computing environment accessible by the PSAP 102.

The PSAP 102 is communicatively connected to a communication network 114 and performs, among other things, computer aided dispatch (CAD) operations to provide emergency services to callers, such as the user 116 (also referred to herein as a “primary user”) illustrated in FIG. 1. The call-taking/dispatching terminal 106 includes, among other things, a processor (for example, a microprocessor or another suitable programmable device), a memory (i.e., a computer-readable storage medium), and one or more input devices, output devices, or input and output devices including, for example, one or more displays, keyboards, keypads, mice, joysticks, touchscreens, speakers, microphones, and/or headsets. Various other components of the PSAP 102, such as the phone system 104, the dispatch system 110, and the emergency notification system 112 can similarly include a processor and a memory storing program instructions executable by the processor to perform the operations described herein.

The components of the PSAP 102 are communicatively coupled using one or more wired and/or wireless networks. A call-taker/dispatcher 108 interacts with the call-taking/dispatching terminal 106 to answer communications, including emergency calls (e.g., 9-1-1 calls) made to and received at the PSAP 102. For example, a user 116, using a mobile communication device 118 (e.g., a telephone, a smart telephone, a tablet computer, or another similar device capable of operating as described herein) places an emergency call using the communication network(s) 114 (e.g., a cellular network, the public switched telephone network, the Internet, or another suitable network), and the call is routed to the PSAP 102.

The phone system 104 routes calls received from callers, such as the user 116, over the communication network(s) 114 to the call-taking/dispatching terminal 106 so that the call-taker/dispatcher 108 may respond to the call. The call may be a voice-based call (e.g., a telephone call, a video call including audio, an audio recording sent via text-to-9-1-1, etc.) or a text-based call (e.g., a multimedia messaging service (MMS) message, a short message service (SMS) message, a real-time text (RTT) message, etc.).

In addition to having the capability of receiving emergency phone calls through the phone system 104, the PSAP 102 also has the capability of receiving information about emergency incidents from an emergency notification system 112. As depicted, the emergency notification system 112 may be remotely located from the PSAP 102, such as at a remote and/or cloud-based server, and communicatively connected to the PSAP 102 over the communication network 114. However, in other examples, the emergency notification system 112 may be implemented in whole or in part at the PSAP 102.

The emergency notification system 112 is configured to receive emergency notifications based on inputs provided by an end-user, such as user 116, via a user interface of an emergency notification application running on the end-user's mobile device, such as mobile device 118. In this regard, the mobile device 118 includes a front-end software application for receiving user input regarding emergency incidents and transmitting associated emergency notification data to the emergency notification system 112 over the communication network(s) 114, and the emergency notification system 112 includes a back-end software application for receiving the emergency notification data over the communication network(s) 114 and providing the emergency notification data to the call-taking/dispatch terminal 106 for presentation to the call-taker/dispatcher 108.

The call-taker/dispatcher 108 interacts with the call-taking/dispatching terminal 106 to dispatch one or more responding officer(s) 120 to respond to the emergency incident for which the user 116 is calling or for which the user 116 has initiated an emergency notification. For example, call-taker/dispatcher 108 inputs information identifying the types and number of responding officer(s) 120 to be dispatched. The call-taking/dispatching terminal 106 provides this information to the dispatch system 110, which then sends a dispatch alert to the mobile device(s) 122 of the responding officer(s) 120 via the communication network(s) 114. The dispatch alert may include information about the incident, such as the incident location, incident type, and identifying information of the user 116.

The dispatch system 110 routes information between the call-taking/dispatching terminal 106 and the mobile device(s) 122 of the responding officer(s) 120 over the communication network(s) 114. In some examples, the routed information includes voice communications between the responding officer(s) 120 and the call-taker/dispatcher 108. In this regard, the mobile device(s) 122 of the responding officer(s) 120 may include a land mobile radio, and the dispatch system 110, the communication network(s) 114, and the mobile device(s) 122 of the responding officer(s) 120 may operate according to a land mobile radio protocol, such as the Project 25 (P25 ) standard developed by the Association of Public-Safety Communications Officials (APCO), the Terrestrial Trunked Radio (TETRA) specification, the Digital Mobile Radio (DMR) standard, the Next Generation Digital Narrowband (NXDN) standard, the Digital Private Mobile Radio (dPMR) standard, and/or the OpenSky standard.

The information routed between the call-taking/dispatching terminal 106 and the mobile device(s) 122 of the responding officer(s) 120 over the communication network(s) 114 may take various other forms as well, such as location data (e.g. GPS data) and/or multimedia data. For instance, the mobile device(s) 122 of the responding officer(s) 120 can include a media capture device, such as a microphone and/or camera (e.g., body-worn camera) configured to capture audio and/or of the surroundings of the responding officer(s) 120. In this regard, the mobile device(s) 122 of the responding officer(s) 120 may capture audio and/or video of interactions between the responding officer(s) 120 and the user 116 or any other individual at the incident scene. In order to provide this captured data to the PSAP 102, the dispatch system 110, the communication network(s) 114, and the mobile device(s) 122 of the responding officer(s) 120 may operate according to a broadband wireless link protocol suitable for transmitting this audio and/or video data, such as the Institute of Electrical and Electronics Engineers (IEEE) 802.11 standard (Wi-Fi), the IEEE 802.16 standard (WiMAX), the Long Term Evolution (LTE) standard, the 5G New Radio (NR) standard, the Code Division Multiple Access 2000 (CDMA 2000 ) standard, the Evolved Packet Core (EPC) standard, and/or one or more satellite broadband protocols.

As noted above, while conventional emergency notification applications can be effective at providing emergency assistance for the primary user 116 or for those in the primary user's immediate vicinity, the present disclosure improves the functionality of emergency notification applications to provide emergency assistance to secondary users 124 remotely located from the primary user 116, such as a child, an elderly, disabled, or infirm family member or friend, or any other individual who may be a dependent of the primary user 116. As used herein, the term “dependent” is not meant to refer to a legal status of an individual, but instead refers to an individual who relies on the primary user 116 for care.

In order to provide such functionality, the public safety communication system 100 may further include one or more cameras 126 arranged to capture video footage of an environment where the secondary user 124 is located. The cameras 126 may provide the captured video footage to the emergency notification system 112, which may be provisioned with one or more video analytics algorithms for identifying the secondary user 124 and determining whether the secondary user 124 is involved in a potential emergency incident, which will be explained in further detail below. Upon detecting a potential emergency incident involving the secondary user 124, the emergency notification system 112 may cause the front-end emergency application on the mobile device 118 to output an alert. The alert may include at least a portion of the video footage in which the potential emergency incident involving the secondary user 124 was detected, as well as a prompt for approving or rejecting activation of an emergency response to the incident. When the primary user 116 inputs a rejection of the activation of the emergency response, the mobile device 118 notifies the emergency notification system 112 of the rejection, and the emergency notification system refrains from taking any actions to initiate an emergency response. When the primary user 116 inputs an approval of the activation of the emergency response, the mobile device 118 notifies the emergency notification system 112 of the approval, and the emergency notification system 112 responsively sends to the PSAP 102 an indication of the emergency incident, which may include the portion of the video footage of the secondary user 124 and a location of the secondary user 124. The PSAP 102 may cause the call-taking/dispatch terminal 106 to display an indication of the emergency incident, and the call-taker/dispatcher 108 may use the dispatch system 110 to dispatch the appropriate responding officers 120 to the location of the secondary user 124 in the manner described above.

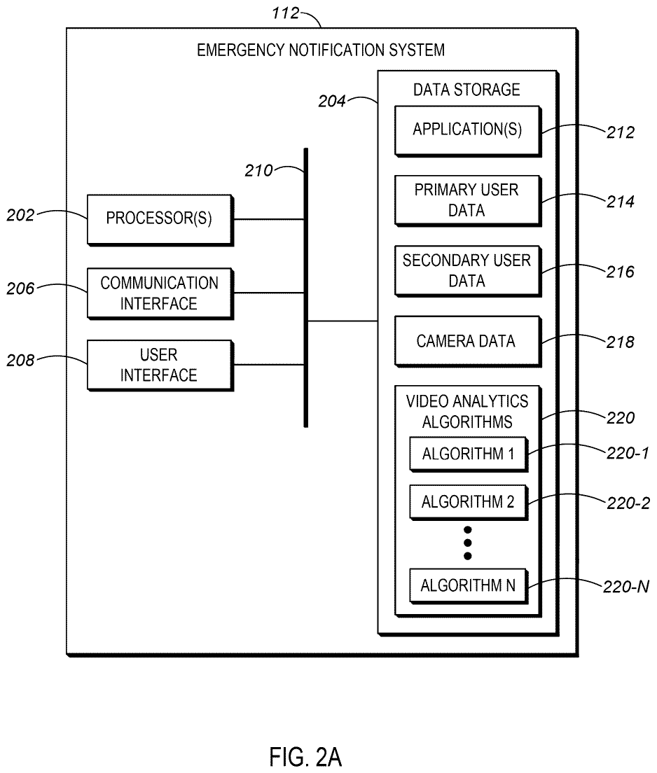

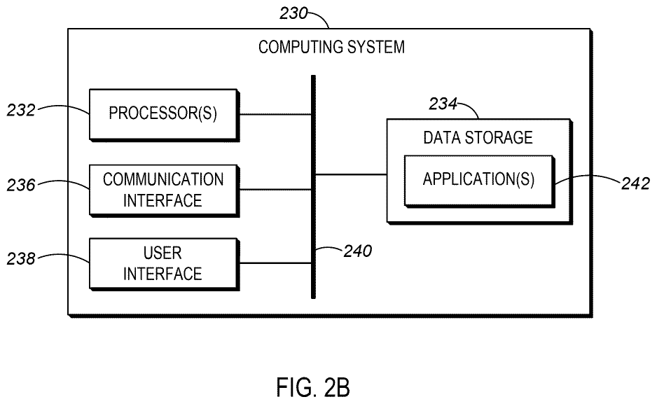

Attention is next directed to FIG. 2A, which depicts a schematic block diagram of an example implementation of the emergency notification system 112. While the emergency notification system 112 is depicted in FIG. 2 as a single component, functionality of the emergency notification system 112 may be distributed among a plurality of components or the like including, but not limited to, any suitable combination of one or more servers, one or more cloud computing devices, one or more routers, one or more proxy devices, or the like. In some examples, some or all of the functionality of the emergency notification system 112 may be integrated with the PSAP 102 and/or the camera(s) 126.

As depicted, the emergency notification system 112 may include one or more processors 202, a data storage 204, a communication interface 206, and a user interface 208, all of which may be communicatively connected by a communication link 210, which may take the form of a system bus or some other connection mechanism.

The processor(s) 202 may comprise one or more processor components, such as general-purpose processors (e.g., a single-or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed.

The data storage 204 may comprise one or more non-transitory computer-readable storage mediums, examples of which may include volatile storage mediums such as random-access memory, registers, cache, etc., and non-volatile storage mediums such as read-only memory, a hard-disk drive, a solid-state drive, flash memory, an optical-storage device, etc. The data storage 204 may also be provisioned with software components that enable the emergency notification system 112 to carry out the operations disclosed herein. For instance, as depicted, the data storage 204 may include one or more software applications 212, such as the back-end software of the emergency notification application described herein, and these software components may generally take the form of program instructions that are executable by the processor(s) 202 to carry out the disclosed operations of the emergency notification system 112.

As further depicted, the data storage 204 may include primary user data 214 and secondary user data 216. The primary user data 214 may include information identifying the primary users of the emergency notification application, such as the primary user 116 depicted in FIG. 1, as well as any other primary users. Examples of such identifying information may include alphanumeric identifiers, such as a user ID or any other type of identifier that could be used to distinguish the primary user 116 from other primary users. The primary user data 214 may also include additional information stored in association with the primary user identifiers, such as personal information about the primary users (e.g., name, address, physical appearance, etc.) as well as information about one or more communications devices of the primary users. For instance, the primary user data 214 may include a phone number of the mobile device 118 and/or various other identifying information of the mobile device 118, such as a model number, serial number, device capabilities and/or compatibilities, or the like. The primary user data 214 may further include information for use when responding to emergency incidents involving the primary user 116 (e.g., the user's medications, allergies, emergency contacts, and the like). Any or all of this primary user data 214 may be stored in association, such as in the form of a user profile.

The secondary user data 216 may similarly include information identifying the secondary users of the emergency notification application, such as the secondary user 124 depicted in FIG. 1, as well as any other secondary users, which may similarly be stored in the form of a user profile. This identifying information can include any or all of the types of identifying information described above in connection with the primary user data 214. Each set of secondary user data 216 corresponding to a respective secondary user may be stored in association with a respective set of primary user data 214 corresponding to a respective primary user. For instance, the user profile for the secondary user 124 depicted in FIG. 1 may be stored in association with the user profile for the primary user 116 depicted in FIG. 1. This association may be based on the secondary user 124 being a dependent of the primary user 116, which may be specified by the primary user 116, as will be explained in further detail below.

The secondary user data 216 for a respective secondary user, such as secondary user 124, may further include information that the emergency notification system 112 can use to detect when the secondary user 124 is involved in a potential emergency incident. As will be explained in further detail below, the emergency notification system 112 may use one or more video analytics algorithms to make such a determination, and these video analytics algorithms may include at least one algorithm for identifying the secondary user 124 within captured video footage. In order to support this functionality, the secondary user data 216 for the secondary user 124 may include any information about the secondary user 124 that the identifying algorithm may use to identify the secondary user 124. One example of such information may include one or more photographs of the face of the secondary user 124, which could be used in connection with a facial recognition algorithm. Another example may include information identifying a wearable device or object that the secondary user 124 wears to visually distinguish the secondary user 124 from other individuals in the captured video footage. Any other applicable examples of information about the secondary user 124 that the identifying algorithm may use to identify the secondary user 124 in the captured video footage are also contemplated herein.

The data storage 204 may further include camera data 218. The camera data 218 may include information identifying each of the cameras 126 depicted in FIG. 1 that are used in connection with the emergency notification system 112. Such identifying information may include an alphanumeric identifier, such as a serial number, a model number, or the like. The camera data 218 may further include location information of each of the cameras 126, which may identify the locations of the environments where the cameras 126 are deployed. Such location information may include GPS coordinates, addresses, building or campus information (e.g., the name of a school, daycare, or other facility where a respective camera 126 is deployed), or the like. Still further, the camera data 218 may include video footage captured by the cameras 126. For instance, the emergency notification system 112 may receive video footage from the cameras 126 and store the video footage in the camera data 218 for use by one or more video analytics algorithms to detect when the secondary user 124 is involved in a potential emergency incident.

The data storage may further include one or more video analytics algorithms 220-1, 220-2, . . . 220-N (referred to herein collectively and generically as video analytics algorithms 220), which, as noted above, the emergency notification system 112 may apply to the video footage captured by the cameras 126 and stored in the camera data 218 to detect when the secondary user 124 is involved in a potential emergency incident. While an “N” number of video analytics algorithms 220 are depicted, the emergency notification system 112 may be configured to use any suitable number of algorithms 220 to detect when the secondary user 124 is involved in a potential emergency incident, such that the number “N” may be any number suitable that depends on the particular implementation of the emergency notification system 112.

The video analytics algorithms 220 may include various different types of algorithms based on the desired types of emergency incidents to be detected and the desired manner of detecting the presence of the secondary user 124. In line with the discussion above, in order to detect the presence of the secondary user 124 in the video footage captured by the cameras 126, the video analytics algorithms 220 may include a facial recognition algorithm for identifying the secondary user 124 based on the one or more photographs of the secondary user 124 in the secondary user data 216. Additionally or alternatively, the video analytics algorithms 220 may include a motion tracking algorithm or object tracking algorithm for tracking the movement of the secondary user 124 and/or for identifying a wearable device or object identified by the secondary user data 216 that the secondary user 124 wears to visually distinguish the secondary user 124 from other individuals in the captured video footage. Further, in order to detect the occurrence of a potential emergency incident, the video analytics algorithms 220 may include one or more of a video analytics algorithm for determining whether the secondary user 124 has fallen, a video analytics algorithm for determining whether the secondary user 124 is engaged in physical violence, a video analytics algorithm for determining whether the secondary user 124 has departed the environment where the secondary user 124 is being monitored, a video analytics algorithm for detecting fire or smoke in the environment of the secondary user 124, or a video analytics algorithm for detecting a weapon in the environment of the secondary user 124. Any other applicable examples of video analytics algorithms for identifying the secondary user 124 and/or for detecting a potential emergency incident in the captured video footage are also contemplated herein.

The video analytics algorithms 220 may take various forms and, in some examples, may include machine learning models that have been trained on extensive datasets to implement the functionalities described above. Further, in some examples, the application(s) 212 of the emergency notification system 112 may be operated in a training mode to train these machine learning models and/or to tune the models based on human feedback, which will be described in further detail below. Such machine learning models may include, but are not limited to: a neural network; a deep-learning based algorithm; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, or the like. And while some algorithms may be better suited for the video analytics functionalities described herein, such as convolutional neural networks (CNNs), recurrent neural networks (RNNs), long short-term memory networks (LSTM), generative adversarial networks (GANs), and transformer networks, it should be understood that any suitable machine learning algorithm and/or deep learning algorithm and/or neural network is within the scope of the present examples.

Returning to the other components of the emergency notification system 112, the communication interface 206 may be configured to facilitate wired and/or wireless communication with other computing devices or systems of the public safety communications system 100. As such, the communication interface 206 may take any suitable form for carrying out these functions, examples of which may include an Ethernet interface, a serial bus interface (e.g., Firewire, USB 3.0, etc.), a chipset and antenna adapted to facilitate wireless communication according to any of the protocols described above in connection with other components of the public safety communications system 100, and/or any other interface that provides for wired and/or wireless communication.

The user interface 208 may include one or more other interfaces that provide connectivity with external user-interface components (sometimes referred to as “peripherals”), such as a keyboard, a mouse or trackpad, a display screen, a touch-sensitive interface, a stylus, a microphone, a headset, speakers, etc., which may allow for direct user interaction with the emergency notification system 112.

It should be understood that the emergency notification system 112 depicted in FIG. 2A is one example of an emergency notification system that may be used with the embodiments described herein. Numerous other arrangements are possible and contemplated herein. For instance, other emergency notification systems may include additional components not pictured and/or more or fewer of the pictured components.

Referring next to FIG. 2B, a schematic block diagram of an example computing system 230 is shown. The computing system 230 may represent a structure of any suitable component of the public safety communications system 100, including, but not limited to, the PSAP 102, the phone system 104, the call-taking/dispatching terminal 106, the dispatch system 110, the emergency notification system 112, the mobile device(s) 118 of the primary user(s) 116, the mobile device(s) 122 of the responding officer(s) 120, and the camera(s) 126. While the computing system 230 is depicted in FIG. 2B as a single component, when the computing system 230 represents a structure of the public safety communications system 100, functionality of the computing system 230 may be distributed among a plurality of components. Further, in such examples, functionality of the PSAP 102, the phone system 104, the call-taking/dispatching terminal 106, the dispatch system 110, the emergency notification system 112, the mobile device(s) 118 of the primary user(s) 116, the mobile device(s) 122 of the responding officer(s) 120, and the camera(s) 126 may be combined in any suitable manner.

As depicted, the computing system 230 may include one or more processors 232, a data storage 234, a communication interface 236, and a user interface 238, all of which may be communicatively connected by a communication link 240, which may take the form of a system bus or some other connection mechanism.

The processor(s) 232 may comprise one or more processor components, such as general-purpose processors (e.g., a single-or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed.

The data storage 234 may comprise one or more non-transitory computer-readable storage mediums, examples of which may include volatile storage mediums such as random-access memory, registers, cache, etc., and non-volatile storage mediums such as read-only memory, a hard-disk drive, a solid-state drive, flash memory, an optical-storage device, etc. The data storage 234 may also be provisioned with software components depicted as application(s) 242, and these software components may generally take the form of program instructions that are executable by the processor(s) 232 to carry out the disclosed operations of the computing system 230. For instance, when the computing system 230 represents components of the mobile device 118 of the primary user 116, the software application(s) 242 may include the front-end software of the emergency notification application described herein.

The communication interface 236 may be configured to facilitate wired and/or wireless communication with other computing devices or systems of the public safety communications system 100. As such, the communication interface 236 may take any suitable form for carrying out these functions, examples of which may include an Ethernet interface, a serial bus interface (e.g., Firewire, USB 3.0, etc.), a chipset and antenna adapted to facilitate wireless communication according to any of the protocols described above in connection with other components of the public safety communications system 100, and/or any other interface that provides for wired and/or wireless communication.

The user interface 238 may include one or more other interfaces that provide connectivity with external user-interface components (sometimes referred to as “peripherals”), such as a keyboard, a mouse or trackpad, a display screen, a touch-sensitive interface, a stylus, a microphone, a headset, speakers, etc., which may allow for direct user interaction with the computing system 230.

It should be understood that the computing system 230 depicted in FIG. 2B is one example of computing system that may be used with the embodiments described herein. Numerous other arrangements are possible and contemplated herein. For instance, other computing systems may include additional components not pictured and/or more or fewer of the pictured components.

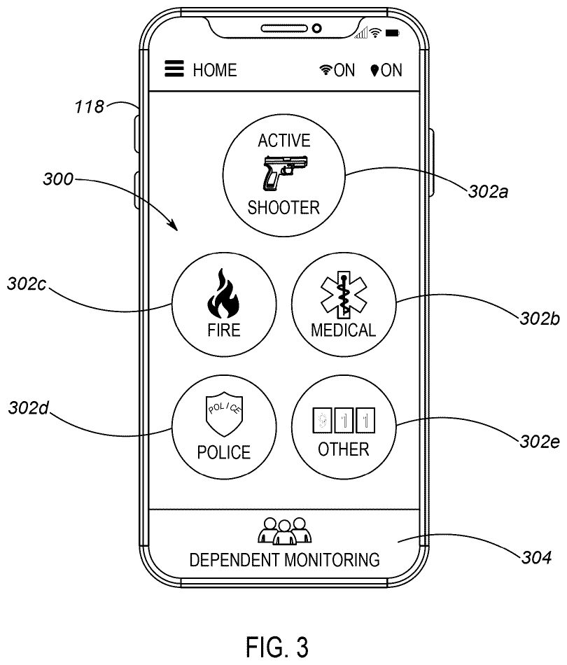

FIG. 3 depicts an example user interface 300 of the front-end emergency notification application running on the mobile device 118 of the primary user 116. As shown, when running the front-end emergency notification application, the displayed user interface 300 may include a number of selectable icons 302a-e (referred to herein collectively and generically as selectable icons 302). These selectable icons 302 may be referred to herein as “panic buttons,” which are buttons that, when actuated, cause the performance of a dedicated emergency response function and typically serve no other purpose. In this regard, upon selection by the primary user 116, each of the selectable icons 302 causes the front-end emergency notification application to perform a respective dedicated emergency alerting function associated with the selected icon 302, as explained in further detail below.

When the primary user 116 selects the active shooter icon 302a, the emergency notification application may cause the mobile device 118 to send an active shooter notification over the communication network(s) 114 to the emergency notification system 112. The active shooter notification can include an identifier of the mobile device 118 (e.g., a phone number, user ID, serial number, or any other identifying information), location data (e.g., GPS data) identifying a location of the mobile device 118, and an alert that an active shooter has been reported.

When the emergency notification system 112 receives the active shooter notification including the identifier of the mobile device 118, the emergency notification system 112 may access the primary user data 214 to locate the user profile of the primary user 116 that is stored in association with the identifier of the mobile device 118. The emergency notification system 112 provides the information in the located user profile, as well as an active shooter alert and the location data of the mobile device 118, to the call-taking/dispatch terminal 106 for presentation to the call-taker/dispatcher 108. The call-taker/dispatcher 108 can then dispatch the responding officer(s) 120 to the location of the mobile device 118 in the manner described above in connection with FIG. 1.

As further shown in FIG. 3, the user interface 300 of the emergency notification application may further include various other selectable icons 302 in addition to the active shooter icon 302a. Examples of these icons include (i) a medical icon 302b, the selection of which causes the mobile device 118 to send a request to the PSAP 102 for emergency medical assistance, (ii) a fire icon 302c, the selection of which causes the mobile device 118 to send an alert to the PSAP 102 that a fire is present and that firefighters should be dispatched to the scene, (iii) a police icon 302d, the selection of which causes the mobile device 118 to initiate a call to the local police station, and (iv) a 9-1-1 icon 302 e, the selection of which causes the mobile device 118 to initiate an emergency phone call to the PSAP 102. Additionally, the selection of each of these other icons 302 may similarly cause the mobile device 118 to send the identifier of the mobile device 118 and the location of the mobile device 118 to the emergency notification system 112, and the emergency notification system 112 may similarly access the user profile of the primary user 116 and provide the user profile information to the appropriate emergency response agency corresponding to the selected icon 302 along with the location of the mobile device 118.

While the aforementioned aspects of the emergency notification application may be useful for the primary user 116 to request emergency assistance for themselves or for others in their immediate vicinity, these functionalities are not well-suited for emergencies involving the secondary user 124 who is remotely located from the primary user 116.

In order to extend the aforementioned functionalities to the secondary user 124, the user interface 300 may further include a dependent monitoring icon 304. Upon selection of the dependent monitoring icon 304, the emergency notification application may cause the mobile device 118 to display one or more interfaces for creating a user profile for the secondary user 124 for purposes of monitoring for emergency incidents involving the secondary user 124, and/or for receiving alerts of emergency incidents involving the secondary user 124 and controlling the emergency responses initiated in connection with such alerts.

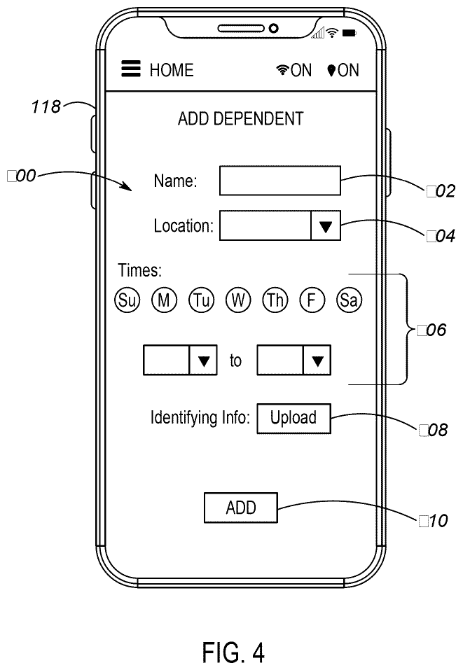

FIG. 4 depicts an example user interface 400 for creating a user profile for the secondary user 124 for purposes of monitoring for emergency incidents involving the secondary user 124. As shown, the user interface 400 may include various data fields and/or selectable icons for providing information about the secondary user 124 and for specifying rules for how the emergency notification system 112 is to monitor for emergencies involving the secondary user 124. It should be understood that the depicted implementations of the various data fields and other data input mechanisms of the user interface 400 are for illustrative purposes and that any suitable data entry methods for inputting the corresponding information are also contemplated herein.

In accordance with the depicted example, the user interface 400 may include a name data field 402 for inputting a name of the secondary user 124. While not depicted, the user interface 400 may additionally or alternatively include one or more other data fields for providing other information that could be used as an identifier of the secondary user 124, such as a user ID.

The user interface 400 may further include a location data field 404 and time data fields 406 for inputting the location and times at which the emergency notification system 112 is instructed to monitor for emergencies involving the secondary user 124. As depicted, the location data field 404 may take the form of a dropdown menu, which may be prepopulated with selectable locations corresponding to the locations of the cameras 126 identified by the camera data 218 in the data storage 204 of the emergency notification system 112. For instance, the prepopulated selectable locations may include the names and/or addresses of the buildings, campuses, or facilities where respective ones of the cameras 126 are deployed. And as further depicted, the time data fields 406 may include a set of selectable icons each corresponding to a respective day of the week, as well as a pair of dropdown menus respectively corresponding to a start time and an end time.

The user interface 400 may further include a data input mechanism for providing identifying information about the secondary user 124 for training one or more of the video analytics algorithms 220 to identify the secondary user 124 in the captured video footage. For instance, as depicted, the user interface 400 may include an upload button 408, the actuation of which causes the mobile device 118 to send any such identifying information input by the primary user 116 to the emergency notification system 112 for storage in the secondary user data 216 in the data storage 204 of the emergency notification system 112. In line with the discussion above, such identifying information may include one or more photographs of the secondary user 124 for training a facial recognition algorithm, and/or one or more photographs or other identifying information of a device or object worn by the secondary user 124 for training an object detection and tracking algorithm.

Further, while not depicted in FIG. 4, the user interface 400 may, in some examples, include one or more data fields for specifying the types of emergency incidents that the emergency notification system 112 is instructed to detect when monitoring the secondary user 124. For instance, the interface 400 may allow the primary user 116 to select from a predefined set of types of emergency incidents that the emergency notification system 112 is capable of detecting. Each type of emergency incident in the predefined set may correspond to one or more of the video analytics algorithms 220 trained to detect that particular type of emergency incident.

As further depicted, the user interface 400 may include an add button 410 or some other mechanism for completing the data entry regarding the secondary user 124 into the interface 400. Upon selection of the add button 410, the mobile device 118 may send the data that was input into the interface 400 to the emergency notification system 112, and the emergency notification system 112 may responsively create a user profile of the secondary user 124 by storing the input data in the secondary user data 216 in the data storage 204 and using the uploaded identifying information to train any of the video analytics algorithms 220 as appropriate.

After creating the user profile of the secondary user 124, the emergency notification system 112 can begin monitoring the secondary user 124 to detect emergency incidents involving the secondary user 124 in accordance with the rules and other data specified by the user profile. Namely, the emergency notification system 112 may monitor the secondary user 124 in accordance with the location and time data input into the location data field 404 and time data fields 406. For instance, using the locations of the cameras 126 specified in the camera data 218, the emergency notification system 112 may determine a subset of the cameras 126 that are deployed at the locations specified by the user profile of the secondary user 124. And the emergency notification system 112 may use that subset of the cameras 126 to detect emergency incidents involving the secondary user 124 by applying one or more of the video analytics algorithms 220 only to video footage that is captured by that subset of cameras during the time periods specified by the user profile of the secondary user 124. Further, in examples where the primary user 116 specified certain types of emergency incidents to monitor for, the emergency notification system 112 may only apply the video analytics algorithms 220 that correspond to the specified types of emergency incidents.

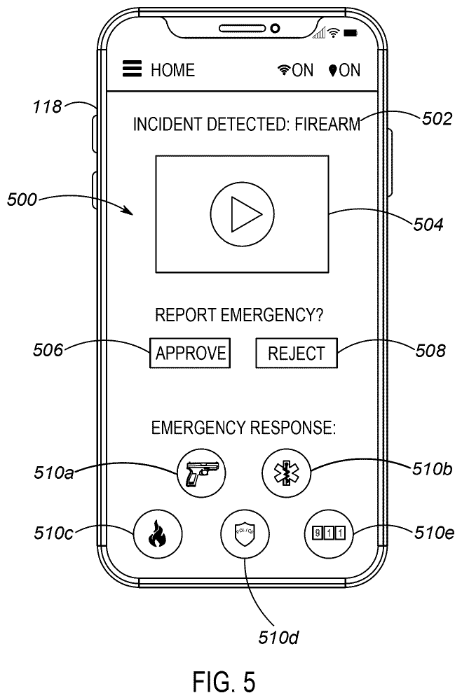

When the emergency notification system 112 detects a potential emergency incident involving the secondary user 124, the emergency notification system 112 may cause the mobile device 118 of the primary user 116 to display an alert via the emergency notification application. FIG. 5 depicts an example user interface 500 of the emergency notification application for displaying such an alert. It should be understood that the depicted implementation of the user interface 500 is for illustrative purposes and that, in other examples, the user interface 500 may provide additional or fewer outputs and/or inputs and/or may provide such outputs and/or inputs in any other suitable manner.

As depicted, the user interface 500 for alerting the primary user 116 of a potential emergency incident involving the secondary user 124 may include an indication of the type of detected emergency incident 502. The indicated type 502 may correspond to the particular video analytics algorithm 220 that was used to detect the incident. For instance, in the depicted example, a firearm detection algorithm detected a firearm in the video footage from one of the cameras 126 monitoring the environment of the secondary user 124, so the indicated emergency incident type 502 is displayed as “firearm.”

The user interface 500 further includes a video player 504 for playing back at least a portion of the video footage in which the emergency incident was detected. Upon selection of the video player 504, the mobile device 118 displays the video footage of the detected incident, such as by streaming or otherwise transmitting the video footage to the mobile device 118 from the camera data 218.

Upon reviewing the video footage via the video player 504, the primary user 116 may evaluate whether an actual emergency incident occurred or whether the alert resulted from a false detection, such as due to imperfections in the video analytics algorithms 220. When the primary user 116 determines that an actual emergency incident occurred, the primary user 116 may select the approve button 506 to approve activation of an emergency response function of the emergency notification system 112. For instance, upon selection of the approve button 506, the mobile device 118 may send an indication of the approval to the emergency notification system 112, and the emergency notification system 112 may responsively carry out the emergency response function. When the primary user 116 determines that no emergency incident occurred, the primary user 116 may select the reject button 508 to reject activation of an emergency response function of the emergency notification system 112. For instance, upon selection of the reject button 508, the mobile device 118 may send an indication of the rejection to the emergency notification system 112, and the emergency notification system 112 may responsively refrain from carrying out the emergency response function.

Further, in some instances, the primary user 116 may be unable to review the video footage in a timely manner to provide an approval or rejection of the emergency response function. Thus, in some examples, the alert may be associated with a timer function. For instance, the emergency notification system 112 may initiate a timer when sending the alert to the mobile device 118, and if the timer expires before the emergency notification system 112 receives an indication of an approval or rejection of the emergency response function, then the emergency notification system 112 may proceed to activate the emergency response function regardless.

The emergency response function carried out by the emergency notification system 112 may take various forms, including any of the emergency response functions described above in connection with FIG. 3. Further, the particular emergency response function that is carried out may depend on the type of detected emergency incident. For instance, if the emergency notification system 112 determines that the detected incident involves a firearm (e.g., based on the alert coming from a firearm detection algorithm), then the emergency notification system 112 may activate an active shooter response function, such as the one described above in connection with FIG. 3. If the emergency notification system 112 determines that the detected incident involves a medical issue (e.g., based on the alert coming from a fall detection algorithm or some other injury detection algorithm), then the emergency notification system 112 may activate a medical response function, such as the one described above in connection with FIG. 3. If the emergency notification system 112 determines that the detected incident involves a fire (e.g., based on the alert coming from a fire detection algorithm), then the emergency notification system 112 may activate a fire response function, such as the one described above in connection with FIG. 3. And if the emergency notification system 112 determines that the detected incident involves some other issue and/or any of the aforementioned issues (e.g., based on the video analytics algorithms causing the alert), then the emergency notification system 112 may activate a police response function and/or a 9-1-1 response function, such as those described above in connection with FIG. 3.

When performing any or all of the aforementioned emergency response functions, the emergency notification system 112 may provide to the PSAP 102, or any other emergency response service associated with the emergency response function, various information for aiding in the emergency response. Such information may include the determined type of the emergency incident, the location of the emergency incident (e.g., based on or including the location data of the camera(s) 126 that captured the video footage of the incident), identifying information of the secondary user 124, and/or the portion of the captured video footage that includes the detected emergency incident.

Further, in some examples, activating the emergency response function may involve initiating various automated emergency response functions at the location of the secondary user 124. For instance, some facilities, such as schools or businesses, may be provisioned with specialized security measures for engaging in a lockdown (e.g., by remotely and electronically locking some or all of the doors in the facility) when there is an active shooter or other emergency incident. Accordingly, when the detected emergency incident involving the secondary user 124 involves the detection of a firearm or a similar incident, activating the emergency response function may involve activating such an automated lockdown procedure at the facility where the secondary user 124 is located.

As further depicted in FIG. 5, the user interface 500 for alerting the primary user 116 of a potential emergency incident involving the secondary user 124 may additionally or alternatively include one or more data inputs for specifying a desired type of emergency response function. For instance, as shown, the user interface 500 may include a number of selectable icons 510a-e (referred to herein collectively and generically as selectable icons 510). These selectable icons 510 may correspond to the selectable icons 302 depicted in FIG. 3 as well as their associated emergency response functions. For example, icon 510a may be associated with an active shooter emergency response function, icon 510b may be associated with a medical emergency response function, icon 510c may be associated with a fire emergency response function, icon 510d may be associated with a local police emergency response function, and icon 510e may be associated with a 9-1-1 emergency response function. Based on the evaluation of the video footage displayed by the video player 504, the primary user 116 may select one of the selectable icons 510 that is associated with the primary user's desired emergency response function to the emergency incident. The mobile device 118 may send an indication of the selected icon 510 to the emergency notification system 112 (e.g., in response to the primary user 116 selecting the approve button 506), and the emergency notification system 112 may responsively activate the emergency response function associated with the selected icon 510.

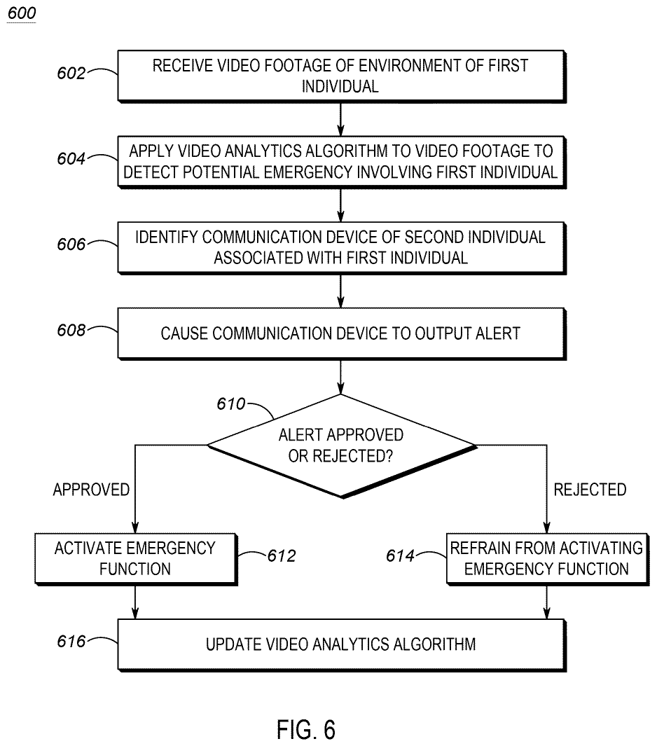

Turning next to FIG. 6, a flowchart of an example method 600 implemented by the emergency notification system 112 for extending the functionality of an emergency notification application (e.g., a “panic button” application) to detect and initiate emergency response efforts for emergency incidents involving a first individual (e.g., the secondary user 124) that is remotely located from a second individual (e.g., the primary user 116) is depicted.

At block 602, the method 600 involves the emergency notification system 112 receiving video footage of an environment of the first individual. In line with the discussion above, the first individual may be the secondary user 124, and the video footage may be received from the camera(s) 126 deployed at a building, campus, or other facility (e.g., school, daycare, house, camp, sporting event, etc.) where the secondary user 124 is located.

At block 604, the method 600 involves the emergency notification system 112 applying a video analytics algorithm to the video footage to detect a potential emergency incident involving the first individual. This may involve the emergency notification system 112 applying one or more of the video analytics algorithms 220 in the manner described above, which may include applying one or more of: (i) a first video analytics algorithm for determining whether the first individual has fallen, (ii) a second video analytics algorithm for determining whether the first individual is engaged in physical violence, (iii) a third video analytics algorithm for determining whether the first individual has departed the environment, (iv) a fourth video analytics algorithm for detecting fire or smoke in the environment, or (v) a fifth video analytics algorithm for detecting a weapon in the environment.

At block 606, the method 600 involves, in response to detecting the potential emergency incident involving the first individual, identifying a communication device of a second individual based on an identifier of the communication device of the second individual being stored in association with an identifier of the first individual. In line with the discussion above, the second individual may be the primary user 116, and the communication device of the second individual may be the mobile device 118. As discussed above, the emergency notification system 112 may identify the mobile device 118 based on the user profiles of the primary user 116 and the secondary user 124 being stored in association with one another in the data storage 204 of the emergency notification system 112. And as further described above, these user profiles may be stored in association with one another based on the secondary user 124 (i.e., the first individual) being a dependent of the primary user 116 (i.e., the second individual).

At block 608, the method 600 involves, in response to detecting the potential emergency incident involving the first individual, causing the communication device of the second individual to output an alert that includes (i) at least a portion of the video footage of the first individual and (ii) a prompt for approving or rejecting activation of an emergency function. This alert corresponds to the alert described above in connection with FIG. 5. And, in some examples, the alert may further include a prompt for an additional user input comprising (i) a type of the emergency incident involving the first individual or (ii) a type of desired emergency response to the emergency incident involving the first individual. In such cases, the emergency notification system 112 may receive, from the mobile device 118, data representing the additional user input, and the emergency notification system 112 may use this data when activating any emergency function (e.g., at block 612 below) by sending an indication of the additional user input to the relevant emergency response service.

In some examples, the method 600 may involve, prior to applying the video analytics algorithm to the video footage, (i) receiving, from the communication device of the second individual, data identifying one or more types of emergency incidents, and (ii) selecting a particular video analytics algorithm based on the particular video analytics algorithm corresponding to the identified one or more types of emergency incidents, such that the act of applying the video analytics algorithm to the video footage comprises applying the selected particular video analytics algorithm to the video footage. In line with the discussion above, the data identifying one or more types of emergency incidents may be specified by the second individual (i.e., the primary user 116) and may be received as part of a process for creating a user profile for the first individual (i.e., the secondary user 124). In this manner, the primary user 116 may control which of the video analytics algorithms 220 are applied to the video footage of the secondary user 124.

Further, in some examples, the method 600 may involve, prior to applying the video analytics algorithm to the video footage, receiving, from the communication device of the second individual (e.g., as part of a process for creating a user profile for the first individual), data identifying a time period or a location, such that the act of applying the video analytics algorithm to the video footage comprises applying the video analytics algorithm to the video footage only during the identified time period or only when the environment of the first individual is at the identified location.

At block 610, the method 600 involves the emergency notification system 112 determining whether the communication device of the second individual has received a user input comprising an approval or rejection of the activation of the emergency function. In line with the discussion above, the emergency notification system 112 may make this determination based on receiving an indication from the mobile device 118 as to whether the primary user 116 selected the approve button 506 or the reject button 508.

If at block 610 the emergency notification system 112 determines that the user input comprises an approval of the activation of the emergency function, then the method 600 advances to block 612. Further, in some examples, the method 600 may advance to block 612 absent such approval. For instance, in line with the discussion above, the prompt for approving or rejecting the activation of an emergency function may be associated with a timer, such that determining whether the communication device of the second individual has received a user input comprising an approval or rejection of the activation of the emergency function may alternatively involve determining that the timer has expired prior to receiving the user input. In such cases, the method 600 may advance to block 612 based on the emergency notification system 112 determining that the timer has expired prior to receiving the user input.

At block 612, the method 600 involves the emergency notification system 112 proceeding to activate the emergency function by establishing a connection with a computing device at the PSAP 102 and sending to the computing device at the PSAP (i) at least the portion of the video footage of the first individual and (ii) a location of the environment of the first individual.

If, however, at block 610 the emergency notification system 112 determines that the user input comprises a rejection of the activation of the emergency function, then the method 600 advances to block 614. And at block 614, the method 600 involves the emergency notification system 112 refraining from activating the emergency function.

From block 612 or 614, the method 600 advances to block 616, at which the method 600 involves the emergency notification system 112 updating the video analytics algorithm that was used to detect the potential emergency incident, such as by automatically tuning the video analytics algorithm based on the user input comprising an approval or rejection of the activation of the emergency function. For instance, when the user input comprises an approval, the emergency notification system 112 may determine that the video analytics algorithm accurately detected the emergency incident, and when the user input comprises an approval, the emergency notification system 112 may determine that the video analytics algorithm inaccurately detected the emergency incident. Based on these two outcomes, the emergency notification system 112 may responsively apply any of various reinforcement learning techniques (e.g., using reinforcement learning from human feedback (RLHF)) to alter one or more parameters of the video analytics algorithm or to train other models for inclusion in the video analytics algorithms 220.

In line with the discussion above, the method 600 extends the functionality of a primary user's emergency notification application (e.g., a panic button application) to provide emergency assistance to a secondary user remotely located from the primary user. Thus, while the aforementioned steps of the method 600 focus on emergency incidents involving the secondary user, the method 600 may further involve functionalities for responding to emergency incidents involving the primary user. In this regard, the method 600 may further involve any of the operations described above in connection with FIG. 3. For instance, the method 600 may involve the emergency notification system 112 receiving, from the communication device of the second individual, a communication indicative of an emergency incident, wherein the communication is received in response to the actuation of a panic button on the communication device of the second individual, and wherein the communication comprises a location of the communication device of the second individual. In response to receiving the communication indicative of the emergency incident, the emergency notification system 112 may establish a connection with the computing device at the PSAP and send to the computing device at the PSAP the location of the communication device of the second individual.

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various examples may be written in an object oriented programming language such as Java, Smalltalk, C++, Python, or the like. However, the computer program code for carrying out operations of various examples may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. An alert system comprising:
a camera arranged to capture video footage of an environment of a first individual;
at least one processor; and
non-transitory, computer-readable data storage comprising program instructions that, when executed by the at least one processor, cause the alert system to perform a set of operations comprising:
receiving the video footage of the environment of the first individual;
applying a video analytics algorithm to the video footage to detect a potential emergency incident involving the first individual;
in response to detecting the potential emergency incident involving the first individual, (i) identifying a communication device of a second individual based on an identifier of the communication device of the second individual being stored in association with an identifier of the first individual, and (ii) causing the communication device of the second individual to output an alert, wherein the alert comprises (a) at least a portion of the video footage of the first individual and (b) a prompt for approving or rejecting activation of an emergency function;
determining whether the communication device of the second individual has received a user input comprising an approval or rejection of the activation of the emergency function;
when the user input comprises an approval of the activation of the emergency function, proceeding to activate the emergency function by establishing a connection with a computing device at a public safety access point (PSAP) and sending to the computing device at the PSAP (i) at least the portion of the video footage of the first individual and (ii) a location of the environment of the first individual; and
when the user input comprises a rejection of the activation of the emergency function, refraining from activating the emergency function.

2. The alert system of claim 1, wherein the first individual is a dependent of the second individual, and wherein the identifier of the communication device of the second individual is stored in association with the identifier of the first individual based on the first individual being a dependent of the second individual.

3. The alert system of claim 1, wherein the prompt for approving or rejecting the activation of an emergency function is associated with a timer, wherein determining whether the communication device of the second individual has received a user input comprising an approval or rejection of the activation of the emergency function comprises determining that the timer has expired prior to receiving the user input, and wherein the set of operations further comprises proceeding to activate the emergency function based on determining that the timer has expired prior to receiving the user input.

4. The alert system of claim 1, wherein the alert further comprises a prompt for an additional user input comprising (i) a type of the emergency incident involving the first individual or (ii) a type of desired emergency response to the emergency incident involving the first individual, wherein the set of operations further comprises receiving data representing the additional user input, and wherein activating the emergency function further comprises sending an indication of the additional user input to the computing device at the PSAP.

5. The alert system of claim 1, the set of operations further comprising automatically tuning the video analytics algorithm based on the user input comprising an approval or rejection of the activation of the emergency function.

6. The alert system of claim 1, wherein the video analytics algorithm comprises at least one of:
a first video analytics algorithm for determining whether the first individual has fallen;
a second video analytics algorithm for determining whether the first individual is engaged in physical violence;
a third video analytics algorithm for determining whether the first individual has departed the environment;
a fourth video analytics algorithm for detecting fire or smoke in the environment; or
a fifth video analytics algorithm for detecting a weapon in the environment.

7. The alert system of claim 1, the set of operations further comprising:
prior to applying the video analytics algorithm to the video footage, (i) receiving, from the communication device of the second individual, data identifying one or more types of emergency incidents, and (ii) selecting a particular video analytics algorithm based on the particular video analytics algorithm corresponding to the identified one or more types of emergency incidents, and
wherein applying the video analytics algorithm to the video footage comprises applying the selected particular video analytics algorithm to the video footage.

8. The alert system of claim 1, the set of operations further comprising:
prior to applying the video analytics algorithm to the video footage, receiving, from the communication device of the second individual, data identifying a time period or a location, and
wherein applying the video analytics algorithm to the video footage comprises applying the video analytics algorithm to the video footage only during the identified time period or only when the environment of the first individual is at the identified location.

9. The alert system of claim 1, wherein the communication device of the second individual is executing an emergency application configured to establish a connection with the PSAP when a panic button of the emergency application is activated,
wherein causing the communication device of the second individual to output the alert comprises causing the communication device of the second individual to output the alert via the emergency application, and
wherein the communication device of the second individual receives the user input comprising the approval or rejection of the activation of the emergency function via the emergency application.

10. A method comprising:
receiving video footage captured in an environment of a first individual;
applying a video analytics algorithm to the video footage to detect a potential emergency incident involving the first individual;
in response to detecting the potential emergency incident involving the first individual, (i) identifying a communication device of a second individual based on an identifier of the communication device of the second individual being stored in association with an identifier of the first individual, and (ii) causing the communication device of the second individual to output an alert, wherein the alert comprises (a) at least a portion of the video footage of the first individual and (b) a prompt for approving or rejecting activation of an emergency function;
determining whether the communication device of the second individual has received a user input comprising an approval or rejection of the activation of the emergency function;
when the user input comprises an approval of the activation of the emergency function, proceeding to activate the emergency function by establishing a connection with a computing device at a public safety access point (PSAP) and sending to the computing device at the PSAP (i) at least the portion of the video footage of the first individual and (ii) a location of the environment of the first individual; and
when the user input comprises a rejection of the activation of the emergency function, refraining from activating the emergency function.

11. The method of claim 10, wherein the first individual is a dependent of the second individual, and wherein the identifier of the communication device of the second individual is stored in association with the identifier of the first individual based on the first individual being a dependent of the second individual.

12. The method of claim 10, wherein the prompt for approving or rejecting the activation of an emergency function is associated with a timer, wherein determining whether the communication device of the second individual has received a user input comprising an approval or rejection of the activation of the emergency function comprises determining that the timer has expired prior to receiving the user input, and wherein the method further comprises proceeding to activate the emergency function based on determining that the timer has expired prior to receiving the user input.

13. The method of claim 10, wherein the alert further comprises a prompt for an additional user input comprising (i) a type of the emergency incident involving the first individual or (ii) a type of desired emergency response to the emergency incident involving the first individual, wherein the method further comprises receiving data representing the additional user input, and wherein activating the emergency function further comprises sending an indication of the additional user input to the computing device at the PSAP.

14. The method of claim 10, further comprising automatically tuning the video analytics algorithm based on the user input comprising an approval or rejection of the activation of the emergency function.

15. The method of claim 10, wherein the video analytics algorithm comprises at least one of:
a first video analytics algorithm for determining whether the first individual has fallen;
a second video analytics algorithm for determining whether the first individual is engaged in physical violence;
a third video analytics algorithm for determining whether the first individual has departed the environment;
a fourth video analytics algorithm for detecting fire or smoke in the environment; or
a fifth video analytics algorithm for detecting a weapon in the environment.

16. The method of claim 10, further comprising:
prior to applying the video analytics algorithm to the video footage, (i) receiving, from the communication device of the second individual, data identifying one or more types of emergency incidents, and (ii) selecting a particular video analytics algorithm based on the particular video analytics algorithm corresponding to the identified one or more types of emergency incidents, and
wherein applying the video analytics algorithm to the video footage comprises applying the selected particular video analytics algorithm to the video footage.

17. The method of claim 10, further comprising:
prior to applying the video analytics algorithm to the video footage, receiving, from the communication device of the second individual, data identifying a time period or a location, and
wherein applying the video analytics algorithm to the video footage comprises applying the video analytics algorithm to the video footage only during the identified time period or only when the environment of the first individual is at the identified location.

18. The method of claim 10, wherein the communication device of the second individual is executing an emergency application configured to establish a connection with the PSAP when a panic button of the emergency application is activated,
wherein causing the communication device of the second individual to output the alert comprises causing the communication device of the second individual to output the alert via the emergency application, and
wherein the communication device of the second individual receives the user input comprising the approval or rejection of the activation of the emergency function via the emergency application.

19. A computing system comprising:
at least one processor; and
non-transitory, computer-readable data storage comprising program instructions that, when executed by the at least one processor, cause the computing system to perform a set of operations comprising:
receiving video footage captured in an environment of a first individual;
applying a video analytics algorithm to the video footage to detect a potential emergency incident involving the first individual;
in response to detecting the potential emergency incident involving the first individual, (i) identifying a communication device of a second individual based on an identifier of the communication device of the second individual being stored in association with an identifier of the first individual, and (ii) causing the communication device of the second individual to output an alert, wherein the alert comprises (a) at least a portion of the video footage of the first individual and (b) a prompt for approving or rejecting activation of an emergency function;
determining whether the communication device of the second individual has received a user input comprising an approval or rejection of the activation of the emergency function;
when the user input comprises an approval of the activation of the emergency function, proceeding to activate the emergency function by establishing a connection with a computing device at a public safety access point (PSAP) and sending to the computing device at the PSAP (i) at least the portion of the video footage of the first individual and (ii) a location of the environment of the first individual; and
when the user input comprises a rejection of the activation of the emergency function, refraining from activating the emergency function.

20. The computing system of claim 19, wherein the set of operations are a first set of operations, and wherein the program instructions, when executed by the at least one processor, further cause the computing system to perform a second set of operations comprising:
receiving, from the communication device of the second individual, a communication indicative of an emergency incident, wherein the communication is received in response to the actuation of a panic button on the communication device of the second individual, and wherein the communication comprises a location of the communication device of the second individual;
in response to receiving the communication indicative of the emergency incident, establishing a connection with the computing device at the PSAP and sending to the computing device at the PSAP the location of the communication device of the second individual.
